(19) United States
(12) Patent Application Publication
(10) Pub. No.: US 2005/0201406 A1
(43) Pub. Date: Sep. 15, 2005

(54) Multicast information delivery system and multicast information delivery method

(75) Inventors: Minoru Sekine, Tokyo (JP); Masashi Tanaka, Tokyo (JP)

Correspondence Address: FOLEY AND LARDNER;SUITE 500, 3000 K STREET NW, WASHINGTON, DC, 20007, US

(73) Assignee: NEC CORPORATION

(21) Appl. No.: 11/063,536

(22) Filed: Feb. 24, 2005

(30) Foreign Application Priority Data
Feb. 26, 2004 (JP) 2004-51745

(51) Int. Cl. H04L 12/28

(52) U.S. Cl. 370/432; 370/390

(57) ABSTRACT

Multicast communication frames for a plurality of channels corresponding to television programs and so on received from an uplink line 130 are subjected to limitation with respect to a total reception amount or limitation according to priorities and sent out from a first priority control section 192, then forwarded onto a backplane bus 128 as ATM cells from an ATM SAR 134. DSL subscriber line termination units 127 refer to their own local multicast distribution tables 211 obtained on the basis of a global multicast distribution table 205 to thereby duplicate as many copies of the ATM cells of the channels concerned as required and send them to corresponding DSL lines.

### BACKGROUND OF THE INVENTION

This invention relates to a multicast information delivery system and a multicast information delivery method for selectively delivering plural-channel communication information to contractors. In particular, this invention relates to a multicast Information delivery system and a multicast information delivery method wherein respective contractors select desired channels from communication information for a plurality of channels of movies, television broadcasts, and so forth and receive delivery thereof.

In an age when each person asserts individuality, diversification of contents such as television programs that these individuals can obtain by broadcast has been strongly demanded. Following this, users have been increasing who are dissatisfied with broadcasts of existing television stations and utilize systems offering multichannel programs such as CATVs (Cable Televisions) for selecting desired programs from more channels.

In an information delivery system for television programs using CATV, coaxial cables are laid between a CATV station and respective contractors' homes. In this information delivery system, since the coaxial cables are used, television programs of as many as several tens of channels can be simultaneously delivered to each of the system contractors' homes and a user can select a desired one of the channels.

FIG. 1 shows a conventional information delivery system 500 for programs in a CATV station 501. In the information delivery system 500, the CATV station 501 distributes a CATV network 504 using coaxial cables 503 to respective contractors' homes 502-1 to 502-P. As described above, each coaxial cable 503 can accommodate many channels. Accordingly, the CATV station 501 can deliver programs of all the channels to setboxes 506 disposed adjacent to televisions 505 of the respective contractors' homes 502-1 to 502-P. In each of the contractors' homes 502-1 to 502-P, it is possible to select programs of desired channels or contracted channels from the delivered programs and watch them by the use of the setbox 506.

That is, in the CATV information delivery system 500, one CATV station 501 can broadcast to the respective contractors' homes 502-1 to 502-P.

On the other hand, following preparation of communication environment on the basis of the Internet, it is becoming possible to receive a relatively large amount of data at low communication charge. Further, technology has been developed about data compression for transmitting image data and sound data in a highly compressed state. Under these circumstances, It is becoming possible to deliver television programs, music programs, movie programs, and the like to respective contractors' homes by the use of an Internet network. However, in a communication system using the Internet network, it is not practical to broadcast programs of many channels to respective contractors' homes as shown in FIG. 1. The biggest reason is that since a data transfer amount, per unit time, of program data such as images and sounds is considerably large per channel, it is difficult to simultaneously deliver data of many programs on the Internet to the respective contractors' homes.

For example, in order to watch a television program composed of images and sounds with relatively good quality, a data transfer amount of 3 Mbps per channel is reportedly necessary. Accordingly, in case of broadcasting a plurality of channels by the use of current ADSL lines, it is only possible to deliver a television program of one channel or television programs of several channels to each contractor's home at maximum. Therefore, each contractor's home must select a channel to be watched from a small number of channels so that there is little room for program selection given to each contractor.

Even if a sufficient number of television programs can be simultaneously delivered to each contractor's home by using another communication technology or owing to further development of the communication technology, when a certain program distribution company continues to deliver a large amount of data to each contractor's home, serious limitation may be given to transmission of other data that commonly uses an Internet network. Thus, this is not preferable. Further, even if data of a plurality of programs are delivered to each contractor's home, when one program is watched at a time, residual program data are all discarded so that unnecessary loads are imposed on the network.

In view of this, it has conventionally been proposed to perform multicast communication with respect to data delivery of a plurality of channels (e.g. Japanese Patent No. 3288365). Note that “multicast communication” Is a technology of transmitting packets with the same contents to a limited specified target group.

FIG. 2 shows an outline of a conventionally proposed information delivery system 520 on the basis of multicast communication. In the information delivery system 520, a server 521 is connected to a bridge 522 via a network 523 and each of hosts 524 is connected to one of network interfaces (IFs) 525-1 to 525-C classified into several groups. The bridge 522 has a function of sorting packets based on MAC (Media Access Control) addresses and therefore is provided not to enter unwanted packets from the network 523.

The bridge 522 comprises a network interface 528 having one end side connected to a backplane bus 527 connecting together the network interfaces 525-1 to 525-C and the other end side connected to the network 523, and a managing interface (IF) 529 that manages the network interfaces 525-1 to 525-C and 528. The managing interface 529 monitors destinations of data that all the hosts 524 transmit and receive, and prepares data bases showing correlation between the hosts and the destinations. Further, among the data bases, the managing interface 529 delivers those data bases, that are individually required by the network interfaces 525-1 to 525-C and 528, to the network interfaces 525-1 to 525-C and 528 as corresponding tables of those data bases.

The server 521 transmits packets by multicast for each of the network interfaces 525-1 to 525-C. These packets are sent to corresponding ones of the network Interfaces 525-1 to 525-C via the network Interface 528 on the basis of the respective corresponding tables. For example, the network interface 525-1 can send by multicast various information such as a television program of a specific channel received from the server 521, to all the hosts 524 belonging thereto. In this manner, in the multicast communication, the network interface 525-1 duplicates copies of the received packets and delivers them to the subordinate hosts 524, With respect to the proposal shown in FIG. 2, the description has been given, as an example, of the case where various information such as television programs is transmitted by multicast from the server 521. On the other hand, various data transmission sources other than the server 521 also exist on the network 523. Packets sent from those data transmission sources are likewise sent to the individual network interfaces 525-1 to 525-C via the network interface 528 and the backplane 527 in the bridge 522. Therefore, even if various data are transmitted by multicast from the server 521, when the total transmission amount increases, the load applied to the backplane bus 527 in the bridge 522 becomes considerably high. As a result, particularly when the server 521 transmits data of which data amounts are large, such as television programs, over a plurality of channels, there arises a problem that reception of packets sent from the other data transmission sources cannot be properly carried out. Further, there is a possibility that reception of even the information sent from the server 521 is degraded to a level that cannot satisfy viewers.

### SUMMARY OF THE INVENTION

It is therefore an object of this invention to provide a multicast information delivery system and a multicast information delivery method that, even when receiving delivery of a relatively large amount of information from a network by multicast, does not cause a bad influence on reception of other information from the network.

It is another object of this invention to provide a multicast information delivery system and a multicast information delivery method that can ensure a necessary quality when receiving delivery of a relatively large amount of information from a network by multicast. A multicast Information delivery system accorridng to a first aspect of this invention comprises a plurality of subscriber line termination units each accommodating an optional number of subscriber lines each connected to a terminal, a packet reception section that, responsive to arrival of a packet addressed to any of the terminals of the plurality of subscriber line termination units, receives the packet, and a common transmission line for transmitting packets received by the packet reception section toward the plurality of subscriber line termination units. The multicast information delivery system further comprises a priority classify section that classifies priorities about forwarding to the common transmission line with respect to the respective packets received by the packet reception section, and a packet forwarding control section that controls a forwarding amount, per unit time, of each of the packets with respect to the common transmission line according to a result of classification by the priority classify section.

In the multicast information delivery system according to the first aspect of this invention, it is configured that when transmitting the packets received by the packet reception section toward the plurality of subscriber line termination units via the common transmission line so that those of the subscriber line termination units corresponding to the destination terminals transmit the packets to the corresponding subscriber lines, the priority classify section judges the priorities about forwarding to the common transmission line with respect to the respective packets received by the packet reception section and, based on a result of this, the packet forwarding control section can control the forwarding amount, per unit time, of each of the packets with respect to the common transmission line. With this configuration, even when packets of television programs or the like are concentrated, the quality of the packets in total can be ensured by preventing a bad influence from being caused on reception of other packets or limiting bands of the packets to proper values when those bands are too broad.

A multicast information delivery system according to a second aspect of this invention comprises a plurality of subscriber line termination units each accommodating an optional number of subscriber lines each connected to a terminal, a packet reception section that, responsive to arrival of a packet addressed to any of the terminals of the plurality of subscriber line termination units, receives said packet, and a packet selection section that selects multicast packets each having a plurality of destinations and unicast packets each having a single destination, from among packets received by the packet reception section. The multicast information delivery system further comprises a common transmission line for transmitting the multicast packets and the unicast packets after being selected by the packet selection section, toward the plurality of subscriber line termination units, and a multicast packet forwarding amount regulating section that is provided between the common transmission line and the packet selection section and regulates a forwarding amount, per unit time, of each of the multicast packets, selected by the packet selection section, to be forwarded to the common transmission line.

In the multicast information delivery system according to the second asepect of this invention, it is configured that when transmits the packets received by the packet reception section toward the plurality of subscriber line termination units via the common transmission line so that those of the subscriber line termination units corresponding to the destination terminals transmit the packets to the corresponding subscriber lines, the forwarding amount, per unit time, of each of the multicast packets to be forwarded to the common transmission line is regulated. With this configuration, even when multicast packets of television programs or the like are concentrated, the quality of the packets in total can be ensured by preventing a bad influence from being caused on reception of unicast packets or limiting bands of the multicast packets to proper values when those bands are too broad depending on kinds of the multicast packets.

According to a third aspect of this invention, a multicast information delivery method is provided. The multicast information delivery method comprises a packet reception step of, when a packet arrived is addressed to any of terminals connected to subscriber lines an optional number of which is accommodated in each of a plurality of subscriber line termination units provided in a subject device, receiving said packet, and a packet forwarding amount regulation step of, when forwarding packets, received in the packet reception step, toward a common transmission line serving to transmit the packets toward the plurality of subscriber line termination units, regulating amounts of the respective packets forwarded to the common transmission line per unit time, depending on the packets and the terminals to which the respective packets are addressed.

In the multicast information delivery method according to the third aspect of this invention, it is configured that, with respect to each of the packets forwarded to the plurality of subscriber line termination units via the common transmission line, the forwarding amount thereof per unit time when forwarding it to the common transmission line is regulated depending on the content and the destination thereof, thereby rationalizing the transmission amount of each of the packets within the range of the allowable value of the common transmission line.

A multicast information delivery method according to a foruth aspect of this invention comprises a packet reception step of, when a packet arrived is addressed to any of terminals connected to subscriber lines an optional number of which is accommodated In each of a plurality of subscriber line termination units provided in a subject device, receiving the packet, and a packet selection step of selecting multicast packets each having a plurality of destinations and unicast packets each having a single destination, from among packets received in the packet reception step. The multicast information delivery method further comprises a multicast packet forwarding amount regulation step of, when forwarding the multicast packets and the unicast packets after being selected in the packet selection step toward a common transmission line serving to transmit the multicast packets and the unicast packets toward the plurality of subscriber line termination units, regulating amounts of the multicast packets forwarded to the common transmission line per unit time, depending on groups of the terminals to which the respective multicast packets are addressed.

In the multicast information delivery method according to the fourth aspect of this invention, it is configured that when transmitting the packets to the plurality of subscriber line termination units via the common transmission line, the amounts of the multicast packets forwarded to the common transmission line per unit time are regulated depending on groups of the terminals to which the respective multicast packets are addressed, thereby ensuring the quality of the packets in total by preventing a bad influence from being caused on reception of unicast packets or limiting bands of the multicast packets to proper values when those bands are too broad depending on kinds of the multicast packets.

As described above, in this invention, when a device in which packets are transmitted to a plurality of subscriber line termination units via a common transmission line exists in a communication system, multicast packets and unicast packets forwarded to the common transmission line are regulated according to destinations or priorities thereof or the total forwarding amount of the multicast packets relative to a forwarding allowable amount with respect to the common transmission line is regulated. Therefore, in packet communication where the common transmission line works as a bottleneck, the respective packets can be received properly on the terminal side. With this configuration, more multicast frames can be made objects of delivery and it is possible to prevent degradation of the quality of contents that require real-time processing such as degradation of the image quality due to signal delay. Therefore, it becomes possible to improve the reliability of information delivery and realize the stable services while suppressing the cost required for constructing and managing the system.

### BRIEF DESCRIPTION OF THE DRAWINGS

FIG. 1 is a system configuration diagram showing an outline of a conventional information delivery system for programs in a CATV station;

FIG. 2 is a system configuration diagram showing an outline of a conventionally proposed information delivery system based on multicast communication;

FIG. 3 is a system configuration diagram showing an outline of a multicast information delivery system for seeing and hearing television images and sounds according to a preferred embodiment of this invention;

FIG. 4 is a block diagram showing an outline of a subscriber line accommodation device and its peripheral circuit configuration in the embodiment of this invention;

FIG. 5 is a block diagram showing a system configuration of the main part of the subscriber line accommodation device in the embodiment of this invention;

FIG. 6 is a block diagram showing an outline of a hardware configuration of an integrated gateway unit in the embodiment of this invention;

FIG. 7 is a block diagram showing an outline of a software configuration of the integrated gateway unit in the embodiment of this invention;

FIG. 8 is a block diagram showing the main part of a circuit for reception processing of multicast packets in the subscriber line accommodation device;

FIG. 9 is an explanatory diagram showing the main part of a global multicast distribution table in the embodiment of this invention;

FIG. 10 is a flowchart showing an outline of frame reception processing implemented by a bridge section in the embodiment of this invention;

FIG. 11 is a flowchart showing an outline of processing implemented by an IGMP snoop section with respect to a frame delivered in step S306 of the flowchart of FIG. 10; and

FIG. 12 is an explanatory diagram showing the main part of a local multicast distribution table in the embodiment of this invention.

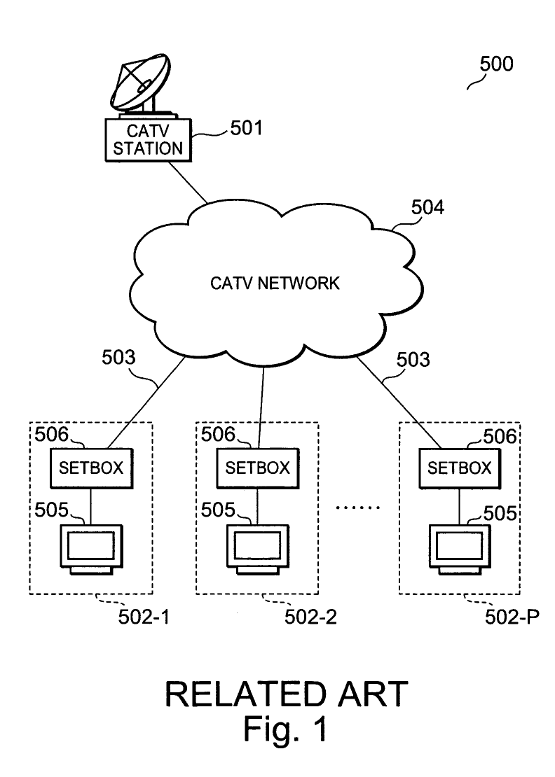

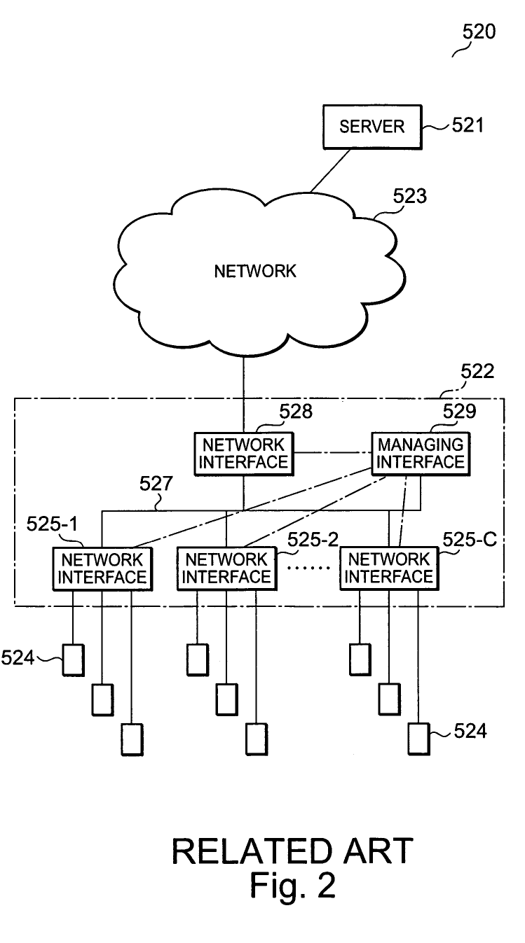

### DESCRIPTION OF THE PREFERRED EMBODIMENT OF THE INVENTION

Now, a preferred embodiment of this invention will be described in detail.

<Outline of System>

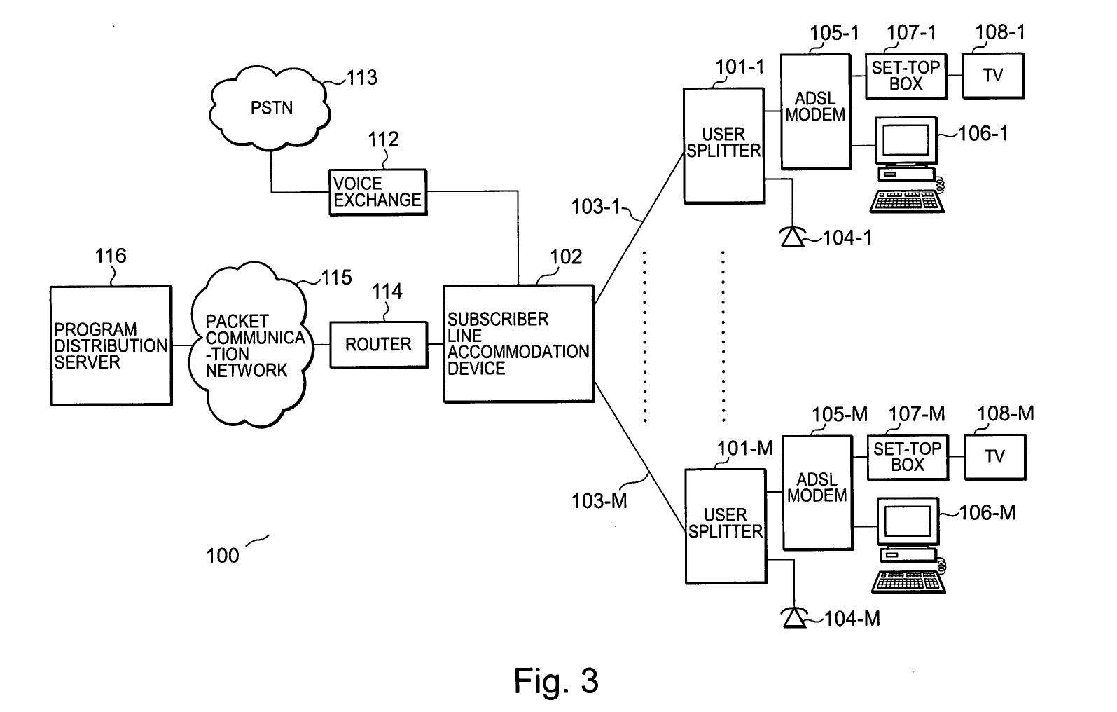

FIG. 3 shows an outline of a multicast information delivery system 100 for seeing and hearing television images and sounds according to this embodiment. The multicast information delivery system 100 uses ADSL (Asymmetric Digital Subscriber Line). In the multicast information delivery system 100, user splitters 101-1 to 101-M respectively disposed at subscribers' (or contractors') homes and a subscriber line accommodation device 102 are connected together via DSL subscriber lines 103-1 to 103-M. Telephones 104-1 to 104-M and ADSL modems 105-1 to 105-M are connected to the user splitters 101-1 to 101-M, respectively. Personal computers 106-1 to 106-M that perform various data processing such as homepage browsing are connected to the ADSL modems 105-1 to 105-M, respectively. Further, Internet televisions 108-1 to 108-M for watching television programs are connected to the ADSL modems 105-1 to 105-M via set-top boxes 107-1 to 107-M, respectively.

The subscriber line accommodation device 102 is connected to a voice exchange 112 and thus is adapted to be connected to a public switched telephone network (PSTN) 113. Further, the subscriber line accommodation device 102 is connected, via a router 114, to a packet communication network 115 such as the Internet for carrying out packet communication. To the packet communication network 115 is connected a program distribution server 116 for distributing various television programs with respect to the Internet televisions 108-1 to 108-M of respective users.

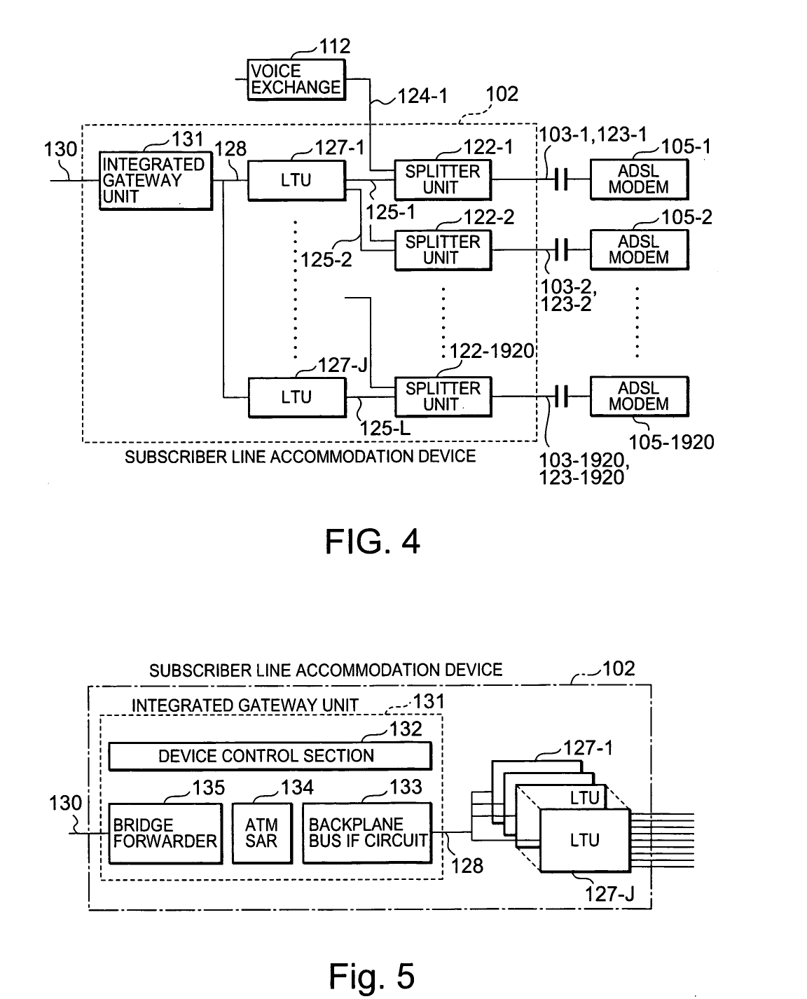

FIG. 4 shows a configuration of the subscriber line accommodation device 102 and Its peripheral configuration. In this embodiment, the subscriber line accommodation device 102 has a capacity of 1920 lines at maximum per system.

The subscriber line accommodation device 102 comprises splitter units 122-1 to 122-1920 connected to the ADSL modems 105-1 to 105-1920 via the DSL subscriber lines 103-1 to 103-1920, respectively. Among them, the splitter unit 122-1 will be representatively described. The splitter unit 122-1 splits a signal 123-1 received via the DSL subscriber line 103-1 into a telephone signal 124-1 of a voice frequency band and an ADSL signal 125-1 of a predetermined frequency band higher than the voice frequency band. The telephone signal 124-1 is sent to the voice exchange 112 serving for line switching.

On the other hand, the ADSL signal 125-1 split by the splitter unit 122-1 is modulated/demodulated at an initial stage (not illustrated) of a corresponding DSL subscriber line termination unit (LTU) 127-1 among DSL subscriber line termination units (LTUs) 127-1 to 127-J so that ATM cells are extracted and then input into an integrated gateway unit (IGU) 131 via a backplane bus 128. Details of the integrated gateway unit 131 will be described later. Each of the DSL subscriber line termination units 127-1 to 127-J comprises DSL transceiver modules (later-described DSP (Digital Signal Processor) corresponding to a predetermined number of lines such as 32 lines at maximum. Each of the DSL subscriber line termination units 127-1 to 127-J performs high-speed data communication in an uplink direction (direction toward the packet communication network 115 in FIG. 3) via an uplink line 130 serving as an interface for connection to the Internet, by the use of the corresponding lines among the DSL subscriber lines 103-1 to 103-1920, while receives and modulates downlink data and sends the modulated downlink data to the corresponding lines among the DSL subscriber lines 103-1 to 103-1920.

FIG. 5 shows a system configuration of the main part of the subscriber line accommodation device 102. The subscriber line accommodation device 102 comprises the DSL subscriber line termination units 127-1 to 127-J described referring to FIG. 4, which are connected to one end side of the integrated gateway unit 131. The integrated gateway unit 131 has an interface function for connection to the Internet and is connected, at its other end side, to the uplink line 130.

The integrated gateway unit 131 comprises a device control section 132 that performs the whole control and monitoring of the subscriber line accommodation device 102, a backplane bus IF (interface) circuit 133 serving as an interface for a backplane, an ATM SAR (Asynchronous Transfer Mode Segmentation and Reassembly) 134 that carries out segmentation and reassembly of ATM (Asynchronous Transfer Mode) cells, and a bridge forwader 135 that performs forwarding at Layer 2 and classifies packets based on MAC (Media Access Control) addresses. The ATM cells are transmitted between the ATM SAR 134 and the DSL subscriber line termination units 127-1 to 127-J, while Ethernet (registered trademark) frames are transmitted at input and output portions of the uplink line 130.

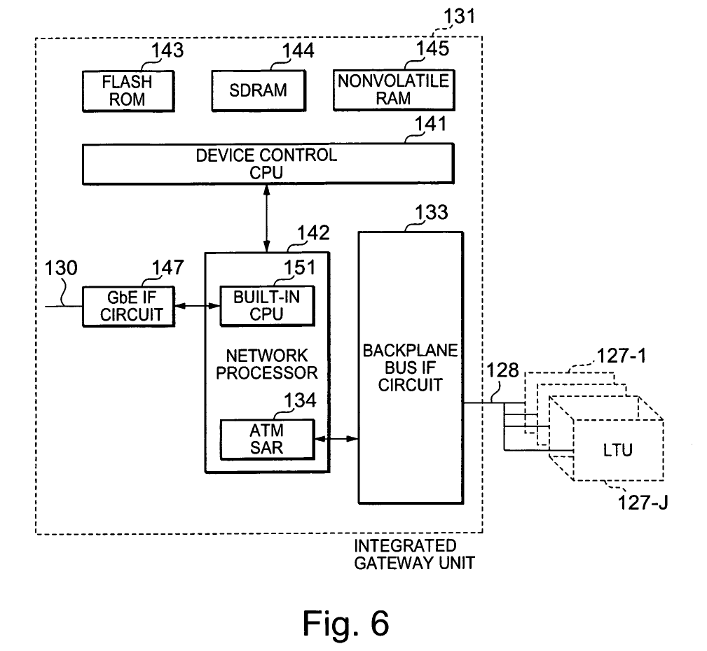

FIG. 6 shows an outline of a circuit configuration of the integrated gateway unit 131. The integrated gateway unit 131 comprises two processors, i.e. a device control CPU (Central Processing Unit) 141 and a network processor 142, a memory group having a flash ROM (Read Only Memory) 143, an SDRAM (Synchronous Dynamic Random Access Memory) 144, and a nonvolatile RAM (Random Access Memory) 145, the backplane bus IF circuit 133 formed by an ASIC (Application Specific Integrated Circuit) as a dedicated integrated circuit, and a GbE (Gigabit Ethernet (registered trademark)) IF (Interface) circuit 147 formed by an LSI (Large Scale Integration) chip (not Illustrated).

The device control CPU 141 executes a control with respect to management, communication, and setting of configuration of the device. The network processor 142 is a high-speed communication processor comprising a built-in CPU 151 and the ATM SAR 134. The bridge forwarder 135 shown in FIG. 5 is created in a software manner by the use of the network processor 142 and carries out processing such as reception of frames, discrimination of destinations, and forwarding to the destinations. The backplane bus IF circuit 133 is created by hardware and executes various controls about the lines such as a control of buses with respect to the lines for carrying out high-speed processing of frames transmitted at gigabit speed. The backplane bus IF circuit 133 processes the DSL subscriber line termination units 127-1 to 127-J individually by polling.

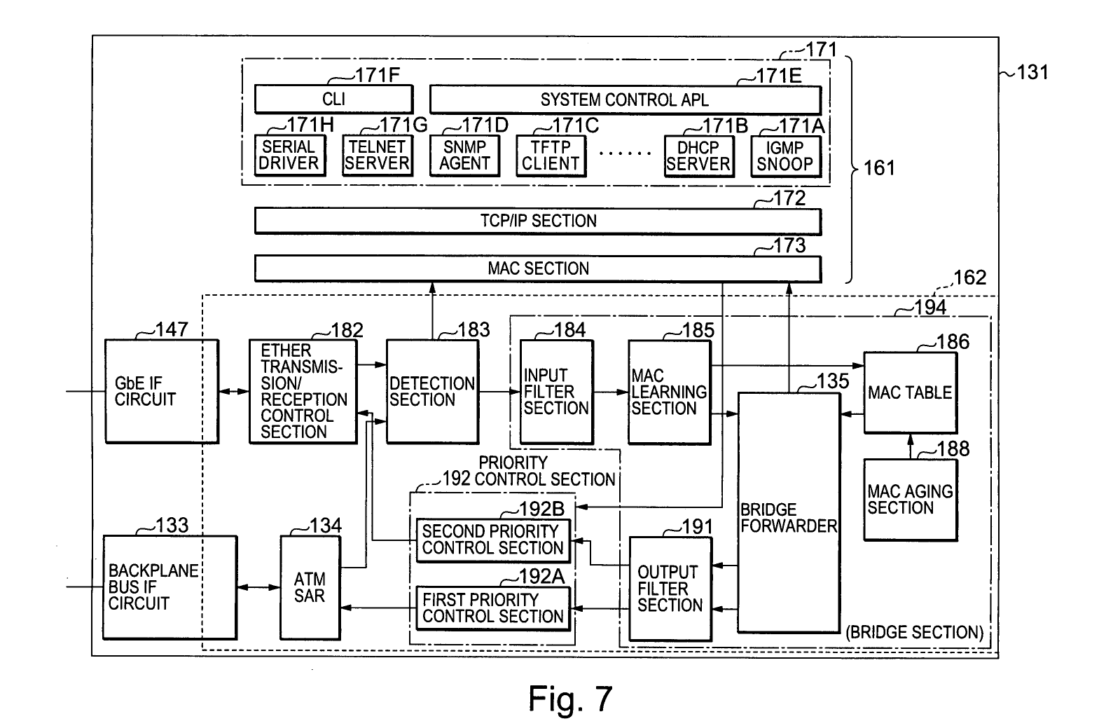

FIG. 7 shows main functional blocks of the integrated gateway unit 131. The integrated gateway unit 131 comprises a basic functional section 161 created by the device control CPU 141 and its associated hardware in FIG. 6, and a signal processing section 162. The signal processing section 162 is created in a software manner by the use of the network processor 142 and its associated hardware in FIG. 6 and a control program. Naturally, the signal processing section 162 can also be created only by hardware.

In this embodiment, the basic functional section 161 comprises a functional software section 171 that performs processing such as communicating with a host (not illustrated) to operate a console (not illustrated), a TCP/IP (Transmission Control Protocol/Internet Protocol) section 172 as a protocol for performing packet communication with the functional software section 171, and an MAC section 173 that manages an MAC (Media Access Control).

In this embodiment, the functional software section 171 is formed by circuits such as an IGMP (Internet Group Management Protocol) snoop section 171A that snoops multicast communication, a DHCP (Dynamic Host Configuration Protocol) server 171B that automatically performs dynamic allocation of IP (Internet Protocol) addresses reusable in an IP network and various setting, a tftp (trivial file transfer protocol) client 171C, an SNMP (Simple Network Management Protocol) agent 171D for device monitoring, a system control application (APL) 171E, a CLI (Command Line Interface) section 171F, a virtual terminal protocol (TELNET) server 171G and a serial driver 171H. Among them, a detailed description will be given later of those that are particularly necessary for describing this Invention.

The signal processing section 162 comprises an Ether transmission/reception control section 182 that performs transmission and reception of frames on the Ethernet (registered trademark) between itself and the GbE IF circuit 147. Packets received from, for example, the program distribution server 116 shown in FIG. 3 via the uplink line 130 shown in FIG. 5 and the Ether transmission/reception control section 182 and packets received from the DSL subscriber line termination units 127-1 to 127-J via the backplane bus IF circuit 133 and the ATM SAR 134 in FIG. 6 are sent to a detection section 183 where a forwarding destination of each packet is sorted into the MAC section 173 or an input filter section 184 included in a bridge section 194. A packet carrying an IGMP control message and an IP packet directed to an IP (Internet Protocol) address of the basic functional section 161 are forwarded to the MAC section 173.

The input filter section 184 serves to block, for example, an illegally accessed Layer 2 frame or Layer 3 packet. The input filter section 184 compares a forwarded packet with a condition registered in advance and discards an agreed packet or passes only an agreed packet. The packet having passed through the input filter section 184 is delivered to a MAC learning section 185. The MAC learning section 185 learns sender MAC addresses of respective received packets and logical port numbers having received the packets and registers these results in a MAC table 186. Then, the packet is delivered to the bridge forwarder 135. The bridge forwarder 135 extracts a destination MAC address from the packet and searches the MAC table 186 to retrieve which of logical ports is connected to the extracted destination MAC address. Even if a transfer destination of a packet to be relayed cannot be found at the beginning to thereby send the packet to all logical ports other than a logical port having received the packet, it becomes possible through such learning of transfer destinations to transfer the packet only to the logical port corresponding to its destination by the use of sender information as a key.

An MAC aging section 188 is connected to the MAC table 186. Even in case of an MAC address stored in the MAC table 186 as a result of the learning, unless the same address is relearned within a preset time, the MAC aging section 188 deletes it from the MAC table 186 as determining that an effective time is over.

The bridge forwarder 135 formed as a Layer 2 forwarder is connected to the MAC learning section 185, the MAC table 186, an output filter section 191, and the MAC section 173. The output filter section 191 corresponds to the input filter section 184 and, after identifying an output logical port corresponding to a destination, discards an inappropriate packet without sending it out in the process of controlling discarding or passing of a frame matching a filtering condition set for the identified output logical port. The conditions used by the output filter section 191 for such filtering are preset by a network manager according to protocols, IP addresses, and input/output logical ports.

On the output side of the output filter section 191 is disposed a priority control section 192 comprising a first priority control section 192A and a second priority control section 192B. The priority control section 192 executes a control of forwarding a particular packet carrying voice or the like which requires real-time transmission, preferentially to other packets. For this control, there exist a priority control that gives priority to a protocol and a priority control that gives priority to an address of a particular destination. A frame heading toward the DSL subscriber line termination units 127-1 to 127-J (FIG. 4) via the first priority control section 192A is forwarded to the ATM SAR 134 where the frame on the Ethernet (registered trademark) is converted into ATM cells which are then sent out to the DSL subscriber line termination units 127-1 to 127-J via the backplane bus IF circuit 133. On the other hand, a frame heading toward the uplink line 130 (FIG. 4) via the second priority control section 192B is forwarded to the Ether transmission/reception control section 182 and then input therefrom into the GbE (Gigabit Ethernet (registered trademark)) IF circuit 147 as it is, i.e. in the form of the frame.

<Processing of Integrated Gateway Unit in Reception>

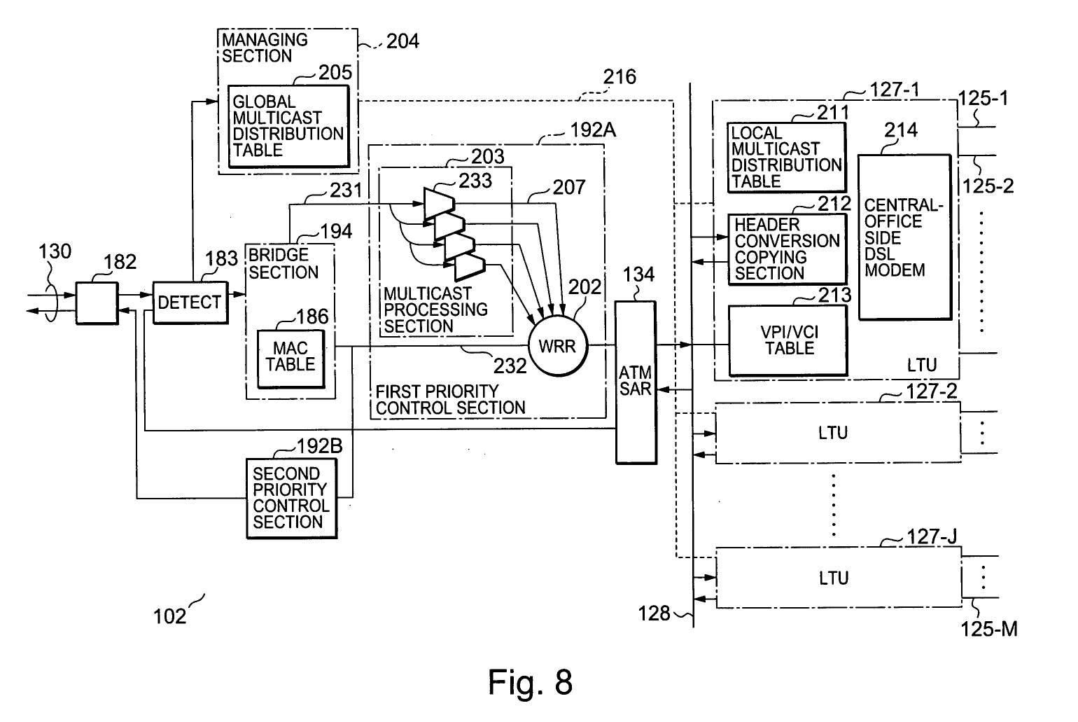

FIG. 8 shows the main part of a circuit for reception processing of multicast packets in the subscriber line accommodation device 102. In the subscriber line accommodation device 102, there are provided the DSL subscriber line termination units 127-1 to 127J, the ATM SAR 134 connected to them via the backplane bus 128, and the bridge section 194 (see also FIG. 7) connected to the uplink line 130. The bridge section 194 includes therein the MAC table 186 describing the results of learning transmission destinations on the basis of senders of packets. Between the bridge section 194 and the ATM SAR 134, there is provided the first priority control section 192A that forwards frames, output from the bridge section 194, to the ATM SAR 134 according to priorities thereof. The first priority control section 192A comprises a forwarding control section (WRR) 202 that allocates forwarding of the frames, received from the bridge section 194, in sequence according to a weighted round robin system, and a multicast processing section 203 that controls a forwarding amount per unit time, of each of the frames per multicast group. Frames heading toward the uplink line 130 from the bridge section 194 pass through the second priority control section 192B and the Ether transmission/reception control section 182 so as to become uplink signals in the uplink line 130.

In a managing section 204 created by the basic functional section 161 shown in FIG. 7, a global multicast distribution table 205 is provided. The global multicast distribution table 205 is a table for associating multicast packets effective in the bridge section 194 with logical ports (port identifiers) of the corresponding lines in the DSL subscriber line termination units 127-1 to 127-J. For example, it is assumed that the Internet television 108-1 connected to the ADSL modem 105-1 shown in FIG. 3 has requested watching a television program of a first channel presented by the program distribution server 116 and that the DSL subscriber line 103-1 of the ADSL modem 105-1 is accommodated In the DSL subscriber line termination unit 127-1. In this case, an identifier of a multicast group corresponding to the television program of the first channel of the program distribution server 116, and a line number and a logical port (ATM-VC (Virtual Channel)) of the DSL subscriber line termination unit 127-1 where the DSL subscriber line 103-1 of the ADSL modem 105-1 is connected, will be described in the global multicast distribution table 205 along with other like combinations already described.

On the other hand, in each of the DSL subscriber line termination units 127-1 to 127-J, there are provided a local multicast distribution table 211 corresponding to the global multicast distribution table 205, a header conversion copying section 212 that performs conversion of a header portion of each ATM cell and duplicates as many copies of each ATM cell as required, a VPI/VCI (Virtual Path Identifier/Virtual Channel Identifier) table 213 as a correlation table between logical ports and ATM-VC identifiers included in ATM cell headers, and a central-office side DSL modem 214 formed by a DSP that performs digital signal processing by programming. The DSL subscriber line termination units 127-1 to 127-J all have the same circuit configuration and therefore the circuit configuration of only the DSL subscriber line termination unit 127-1 is shown in FIG. 8. Since the backplane bus 128 is used for transferring ATM packets, a control-dedicated interunit communication channel 216 is arranged between the managing section 204 and the DSL subscriber line termination units 127-1 to 127-J, apart from the backplane bus 128. Using this interunit communication channel 216, the managing section 204 polls the DSL subscriber line termination units 127-1 to 127-J to thereby update the local multicast distribution tables 211, respectively, The global multicast distribution table 205 arranged in the managing section 204 is prepared based on information obtained from the IGMP snoop section 174 constituting the basic functional section 161 shown in FIG. 7. Specifically, in the case of watching the television program of the first channel as an example, the IGMP snoop section 174 recognizes multicast packets sent from the program distribution server 116 so as to be associated with individual delivery destinations (logical ports (port identifiers) on the DSL subscriber lines 103-1 to 103-M corresponding to the Internet televisions 108-1 to 108-M in FIG. 3) in the DSL subscriber line termination units 127-1 to 127-J and feeds these information to the managing section 204. In the case of the program distribution server 116 as an example, the managing section 204 prepares, based on these obtained information, the global multicast distribution table 205 in which multicast groups defined on a basis of television program channels are associated with the corresponding port identifiers.

The backplane bus 128 shown in FIG. 4 may be called a common transmission line claimed in claim 1. The GbE IF circuit 147, the Ether transmission/reception control section 182, and the detection section 183 shown in FIG. 7 are collectively serves as a packet reception section claimed in claim 1. The bridge section 194 and the first priority control section 192 shown in FIG. 7 collectively serves as a priority classify section claimed in claim 1. The first priority control section 192A also serves as a packet forwarding control section claimed in claim 1. The bridge section 194 also serves as a packet selection section claimed in claim 2. The shapers 233 in the multicast processing section 203 (FIG. 8) serve as a multicast packet forwarding amount regulating section claimed in claim 2. The managing section 204 shown in FIG. 8 serves as a global multicast distribution table preparing section claimed in claim 8. The managing section 204 and the local multicast distribution table 211 serve as a local multicast distribution table preparing and updating section claimed in claim 9. The bridge section 194, the multicast processing section 203, and the managing section 204 collectivley serves as a total amount judgement section and an upper limit value changing section both of which are claimed in claim 10.

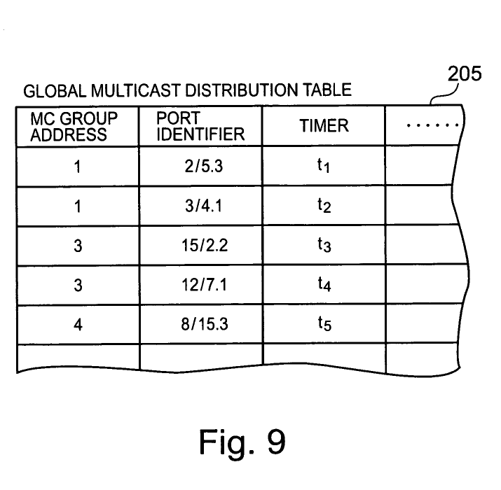

FIG. 9 shows the main part of the global multicast distribution table 205. In the global multicast distribution table 205, addresses of the multicast groups (MC group addresses) for each of which the same packets are transmitted by multicast are respectively described on a basis of the DSL subscriber line termination units 127-1 to 127-J. The global multicast distribution table 205 thus configured is used by the managing section 204 for processing frames sent by multicast and for preparing and updating the local multicast distribution tables 211 arranged in the DSL subscriber line termination units 127-1 to 127-J, respectively.

In the case of the program distribution server 116 shown in FIG. 3 as an example, “MC Group Address” in the global multicast distribution table 205 shown in FIG. 9 identifies multicast group addresses that correspond to the channels of the television programs, respectively. For example, a multicast group address of “1” represents “first channel”, while a multicast group address of “3” represents “third channel”. In the global multicast distribution table 205, each multicast group address is associated with predetermined information such as a port identifier and a timer.

In the global multicast distribution table 205, “Port Identifier” identifies a slot number, a number of a physical port, and a number of a logical port in the physical port, of corresponding each of the DSL subscriber line termination units 127-1 to 127J. For example, “2/5. 3” in “Port Identifier” represents a third logical port of a fifth physical port in the DSL subscriber line termination unit 127-2. When physical ports and logical ports are in one-to-one correspondence with each other, since each physical port has the single logical port, it is not necessary to describe numbers of the logical ports in a communication system thus configured. In the case of using the ATM-VC, since a plurality of logical lines (VC) can be prepared with respect to one physical line, the numbers of the logical ports are used. When a port identifier is given as “X/Y, Z” in “Port Identifier”, “X” represents a number of a corresponding one of the DSL subscriber line termination units 127-1 to 127-J, “Y” a line number (physical port), and “Z” a logical port.

“Timer” represents a time when corresponding information was written in the global multicast distribution table 205 or a time when content was updated. When this time becomes older than a current time by a predetermined time or more, a deletion is made from the global multicast distribution table 205. This is carried out for preventing a situation where, for example, even after a user has finished watching a television program, that television program is delivered to the user.

Other information described in the global multicast distribution table 205 may be information indicative of priorities in frame distribution or information indicative of kinds of data sent in frames. These information are also obtained by the managing section 204 from the IGMP snoop section 174 and can be used for a band limitation control when ATM cells forwarded onto the backplane bus 128 from the ATM SAR 134 exceed a forwardable upper limit value.

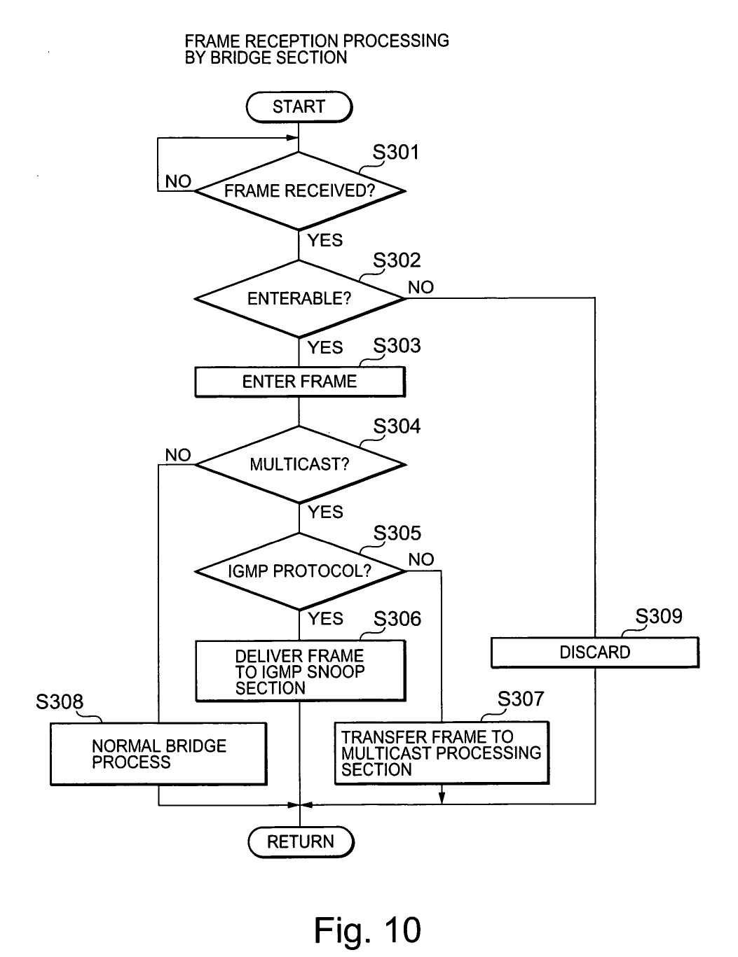

FIG. 10 shows the flow of frame reception processing implemented by the bridge section 194. When a frame is sent from the uplink line 130 (step S301: Y), the bridge forwarder 135 judges from a destination thereof whether or not the frame can be entered into the subscriber line accommodation device 102 (step S302). In this judgment, the bridge forwarder 135 refers to the set conditions of the device and the registration state of the global multicast distribution table to thereby judge whether or not the frame should be multicast delivered. When the destination agrees, the frame is entered (step S302: Y, step S303). Then, it is judged whether or not the frame was sent by multicast (step S304). If the frame was sent by multicast (step S304: Y), it is judged whether or not the IGMP protocol was used (step S305). If positive (step S305: Y), the frame is forwarded to the IGMP snoop section 171A (step S306). If negative (step S305: N), the frame is transferred to the multicast processing section 203 described referring to FIG. 8 (step S307). If it is judged in step 8304 that the frame was not sent by multicast (step S304: N), a normal bridge process such as filtering, learning, and bridging is carried out (step S308). On the other hand, if it is judged in step S302 that the frame should not be entered (step S302; N), the frame is discarded (step S309).

In this embodiment, after the multicast packet is selected by the sequence shown in FIG. 10, the unicast packet is subjected to filtering and learning. However, this invention is not limited thereto. For example, filtering and learning may first be carried out, then the selection of a multicast packet shown in FIG. 10 may be carried out.

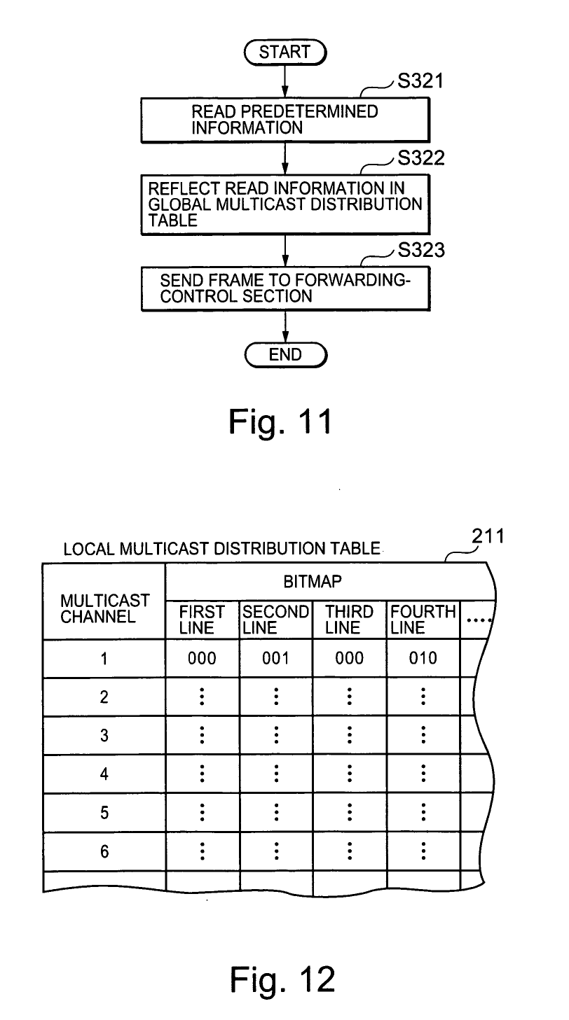

FIG. 11 shows the flow of processing implemented by the IGMP snoop section 171A with respect to the frame received in step S306. In the IGMP snoop section 171A, this processing is performed by the program. Specifically, the IGMP snoop section 171A reads predetermined information from the received IGMP protocol frame (step S321) and reflects it in the global multicast distribution table 205 of the managing section 204 (step S322). The frame 232 (see FIG. 8), after the information thereof is snooped, is sent to a predetermined destination. The IGMP packet is subjected only to the information reading and is relayed, without any change in principle, to the destination where it should primarily be sent (step S323).

In the multicast processing section 203 shown in FIG. 8, there are provided shapers 233 for implementing band limitation corresponding to the multicast groups, respectively. Based on the priority of frames or the kind of data and information indicative of the congestion degree of ATM cells given from the bridge section 194, each shaper 233 adjusts a band for the corresponding multicast group in forwarding ATM cells onto the backplane bus 128. For example, with respect to frames of television programs addressed to any of the Internet televisions 108-1 to 108-M shown in FIG. 3, the band limitation is implemented to a band of, for example, 3 Mbps per channel so as not to occupy a band more than necessary. Frames 207 thus subjected to the band limitation per multicast group are fed to the forwarding control section 202. Naturally, it is possible that a network manager sets bands of the individual shapers 233 based on experience and so on.

A description will be given of a case where a band occupied by total multicast communication frames is adjusted by an algorithm on the device side. Specifically, assuming that the ratio of an amount allowed in multicast communication per unit time is 10% relative to the maximum amount of ATM cells that can be forwarded onto the backplane bus 128 per unit time, the band limitation is implemented so that an amount of ATM cells that are converted at the ATM SAR 134 from frames received from the forwarding control section 202 and then forwarded onto the backplane bus 128 falls within the range of 10%. For example, in the case where the maximum allowable amount of ATM cells forwarded onto the backplane bus 128 is 1 Gbps, the total of the multicast communication frames 207 fed to the forwarding control section 202 is controlled to a band of 100 Mbps. Assuming that all that are delivered from the program distribution server 116 shown in FIG. 3 are television programs, if each channel is limited to the band of 3 Mbps, frames of about 32 channels are fed to the forwarding control section 202 from the multicast processing section 203.

In the case where, as different from the case where only the television programs are simply delivered, various kinds of multicast communication frames are input into the multicast processing section 203, frames of images or sounds that are highly necessary to be reproduced in real time, frames carrying urgent information such as disaster information, or frames addressed to preset ports given priority are preferentially assigned bands and fed to the forwarding control section 202 from the multicast processing section 203. The description has been made herein that the total amount of frames sent to the forwarding control section 202 from the multicast processing section 203 is fixed relative to the maximum allowable amount of ATM cells forwarded onto the backplane bus 128 per unit time. However, it may also be configured that the total amount of ATM cells actually flowing on the backplane bus 128 is detected and, when this amount is less than a predetermined reference value, the band limitation implemented by the multicast processing section 203 is relaxed corresponding thereto or the band limitation is not carried out. This may be achieved by, for example, successively monitoring, at the managing section 204, reception amounts of downlink frames in the uplink line 130 and feeding this result to the multicast processing section 203 via the bridge section 194 or the like, thereby dynamically controlling the upper limit value of the total amount regulation thereof.

To sum up, rather than how to control the allowable amount per channel in multicast communication, what is important is a scheduling that each channel is used to its maximum value within the range of the maximum allowable capacity of the backplane bus 128. Even with respect to the limitation to the band of 3 Mbps per channel as described above, there also exists such a server that temporarily requires a larger band in a burst fashion. Therefore, by increasing the upper limit from the limitation to the band of 3 Mbps to limitation to a band of 5 Mbps, it becomes possible, while allowing communication with a little burst, to perform shaping of traffics with respect to a transmission source having more burst. This ensures smoothing of the bands and enables a band control that prevents inconvenience such as temporary buffer exhaustion in a device portion or a network arranged at a later stage.

The forwarding control section 202 selects the respective multicast communication frames 207 sent from the multicast processing section 203 and the frames 232, other than the multicast communication frames, directly sent from the bridge section 194, in sequence in the round robin fashion and forwards the selected frames to the ATM SAR 134. The ATM SAR 134 divides each frame into ATM cells and forwards them onto the backplane bus 128.

In this embodiment, the multicast processing section 203 performs the band control of the individual multicast communication frames. On the other hand, it may also be configured that the multicast processing section 203 sets a band limitation value per frame and, based on such information, the forwarding control section 202 forwards respective frames while adjusting the ratio of forwarding amounts per unit time. In this case, as one example, the forwarding control section 202 is provided with a buffer memory per frame and forwards the frames preferentially from the buffer memories having higher priorities to the ATM SAR 134.

FIG. 12 shows one example of a structure of the local multicast distribution table 211. This figure shows, as one example, content of the local multicast distribution table 211 of the DSL subscriber line termination unit 127-1 shown in FIG. 8. With respect to ATM cells to be relayed by the DSL subscriber line termination unit 127-1, the local multicast distribution table 211 describes port identifiers for those ATM cells to be output therefrom, which are described in the global multicast distribution table 205 shown in FIG. 9, as bitmap data expressing the lines of the DSL subscriber line termination unit 127-1 in the form of a list. Assuming that the DSL subscriber line termination unit 127-1 accommodates 32 lines among the DSL subscriber lines 103 (FIG. 3) and that three logical ports are set to each of the lines, a bitmap composed of 96 bits of which 3 bits are used as a unit for identifying the three logical ports of each line is allocated to each of multicast channels corresponding to the television program channels. For example, the first channel in the local multicast distribution table 211 is delivered to the third logical port of the DSL subscriber line 103-2, the second logical port of the DSL subscriber line 1034, and so on.

Among ATM cells flowing on the backplane bus 128 shown in FIG. 8, each of the ATM cells corresponding to multicast communication frames has, at its predetermined position, a flag (identification information) indicating that it is a multicast packet, and a following bit string with a predetermined number of bits forming a multicast group identifier identifying a multicast group to be received. These flag and identifier can be described using a description field for a virtual path identifier and a virtual channel identifier (VPI/VCI) in a cell header. When any of the DSL subscriber line termination units 127-1 to 127-J refers to the flag of the corresponding ATM cell and judges that it is the multicast packet, it then refers to the local multicast distribution table 211 shown in FIG. 12. Accordingly, the subject DSL subscriber line termination unit 127 can judge which logical port of which physical port the packet should be sent to. When there are a plurality of transmission destinations, the subject DSL subscriber line termination unit 127 duplicates copies of the ATM cell and writes, into a cell header of each copy, VPI/VCI being a virtual path identifier and a virtual channel identifier for ATM communication of a corresponding logical port. This means that the flag indicative of the multicast packet and the multicast group identifier have been converted Into the VPI/VCI. By repeating this conversion for each of the logical ports concerned, i.e. writing the VPI/VCI In the cell header of each copy as described above, the subject DSL subscriber line termination unit 127 performs transmission to all the ports specified in the local multicast distribution table 211. Such conversion and copying are carried out in the header conversion copying section 212. The central-office side DSL modem 214 performs ADSL modulation of the ATM cell fed per logical part and sends it out to a corresponding one of the DSL subscriber lines 103-1 to 103-384.

Multicast communication frames sent to the subscriber line accommodation device 102 shown in FIG. 8 from the uplink line 130 include such a frame that is registered in the global multicast distribution table 205, such a frame that is not yet registered therein, such a frame that has once been registered therein but already been deleted and enters the multicast processing section 203 and is staying therein, and so on. Even when a frame of a certain multicast group that is not registered in the global multicast distribution table 205 for some reason has passed through the multicast processing section 203 and the forwarding control section 202, such a frame is resultantly discarded in any of the DSL subscriber line termination units 127-1 to 127-J shown in FIG. 6. Specifically, the multicast group that is not registered in the global multicast distribution table 205 resultantly has no corresponding bitmap in any of the local multicast distribution tables 211 of the DSL subscriber line termination units 127-1 to 127-J. Consequently, multicast packets of that group are discarded in all the DSL subscriber line termination units 127-1 to 127-J.

In this embodiment as described above, the multicast communication frames are subjected to the band adjustment per group in the first priority control section 192A. Therefore, with respect to what requires real-time processing such as the television program, it is possible to ensure the communication satisfying such requirement. Further, since the communication other than the multicast communication is not suppressed, it is possible to achieve the harmony of the whole communication system using the ADSL modems 105-1 to 105-M.

In the embodiment, the ATM cells are transferred on the backplane bus 128. However, this invention is not limited thereto. For example, frames on the Ethernet (registered trademark) may be transferred on the backplane bus 128 as they are in the form of multicast communication. In this case, the flags indicative of multicast communication are not particularly provided as in the case of the ATM cells, and the frames are taken into corresponding one or more of the DSL subscriber line termination units 127-2 to 127-J depending on MAC addresses of destinations described in headers thereof. Therefore, it is possible to efficiently perform multicast communication extending over the plurality of DSL subscriber line termination units 127. In this case, the frames having high priorities may be secured in advance as preferential packets that are forwarded onto the backplane bus 128 with a fixed period.

Further, in the embodiment, the description has been given of the multicast communication using the ADSL signals. However, this invention is also applicable to communication of other DSL types or the type employing optical subscriber lines. Furthermore, in the embodiment, by the use of the control-dedicated interunit communication channel 216, the managing section 204 sends data relating to the local multicast communication tables 211 to the respective DSL subscriber line termination units 127-1 to 127-J. However, as long as the quickness of communication is ensured, the backplane bus 128 or a similar common transmission line may be used to thereby perform the same processing.

Moreover, in the embodiment, the forwarding control section 202 executes the priority control only for the individual multicast communication frames. However, it is possible to also implement a priority control for unicast communication frames. Scheduling of this priority control can be performed integrally with forwarding of the multicast communication frames by the use of the weighted round robin (WRR) system or another algorithm. For example, it is effective to provide a multicast information delivery system wherein packets according to IP (Internet Protocol) telephones are given the highest priority, multicast communication frames are forwarded in a constant band with a lower priority, and data communication such as access to Web sites is scheduled with a further lower priority.

1. A multicast information delivery system comprising:
a plurality of subscriber line termination units each accommodating an optional number of subscriber lines each connected to a terminal;
a packet reception section that, responsive to arrival of a packet addressed to any of the terminals of said plurality of subscriber line termination units, receives said packet;
a common transmission line for transmitting packets received by said packet reception section toward said plurality of subscriber line termination units;
a priority classify section that classifies priorities about forwarding to said common transmission line with respect to the respective packets received by said packet reception section; and
a packet forwarding control section that controls a forwarding amount, per unit time, of each of the packets with respect to said common transmission line according to a result of classification by said priority classify section.

2. A multicast information delivery system comprising:
a plurality of subscriber line termination units each accommodating an optional number of subscriber lines each connected to a terminal;
a packet reception section that, responsive to arrival of a packet addressed to any of the terminals of said plurality of subscriber line termination units, receives said packet;
a packet selection section that selects multicast packets each having a plurality of destinations and unicast packets each having a single destination, from among packets received by said packet reception section;
a common transmission line for transmitting the multicast packets and the unicast packets after being selected by said packet selection section, toward said plurality of subscriber line termination units; and
a multicast packet forwarding amount regulating section that is provided between said common transmission line and said packet selection section and regulates a forwarding amount, per unit time, of each of the multicast packets, selected by said packet selection section, to be forwarded to said common transmission line.

3. A multicast information delivery system according to claim 2, further comprising a priority classify section that classifies priorities about forwarding to said common transmission line with respect to the respective multicast packets selected by said packet selection section,
wherein said multicast packet forwarding amount regulating section regulates the forwarding amount, per unit time, of each of the multicast packets to be forwarded to said common transmission line, depending on the priority classified by said priority classify section.

4. A multicast information delivery system according to claim 3, wherein said forwarding amount is regulated by setting a ratio of a total amount of the multicast packets occupying a maximum allowable amount of packets that are forwarded to said common transmission line, to a predetermined upper limit value.

5. A multicast information delivery system according to claim 1 or 3, wherein said priority classify section classifies the priority depending on whether or not the packet is addressed to a particular one of the terminals.

6. A multicast information delivery system according to claim 1 or 3, wherein said priority classify section classifies the priority depending on whether or not data carried in the packet is data that should be reproduced in real time.

7. A multicast information delivery system according to claim 3, wherein said multicast packet forwarding amount regulating section limits forwarding of the respective multicast packets that are classified by said priority classify section to have a priority of being addressed to the terminals that receive television images, to a predetermined bandwidth necessary for reproducing the television images.

8. A multicast information delivery system according to claim 2, further comprising a global multicast distribution table preparing section that prepares a global multicast distribution table indicating one of said plurality of subscriber line termination units, a subscriber line of said one of the plurality of subscriber line termination units, and a logical port of said subscriber line, as a delivery destination for each of the received multicast packets,
wherein the multicast packets are sent to the corresponding subscriber line termination units via said common transmission line by referring to said global multicast distribution table prepared by said global multicast distribution table preparing section.

9. A multicast information delivery system according to claim 8, further comprising a local multicast distribution table preparing and updating section that prepares local multicast distribution tables based on said global multicast distribution table and updates contents thereof, said local multicast distribution tables individually required by said plurality of subscriber line termination units,
wherein said subscriber line termination units respectively refer to their own local multicast distribution tables to thereby send the multicast packets to subscriber lines of reception destinations.

10. A multicast information delivery system according to claim 4, further comprising:
a total amount judgment section that judges a total amount, per unit time, of the packets forwarded to said common transmission line; and
an upper limit value changing section that changes, depending on a result of judgment by said total amount judgment section, the upper limit value of the ratio occupied by the total amount of the multicast packets.

11. A multicast information delivery system according to claim 1 or 2, wherein the packets forwarded to said common transmission line are ATM packets of which each multicast packet has a header added with identification information indicative of being a multicast packet.

12. A multicast information delivery method comprising:
a packet reception step of, when a packet arrived is addressed to any of terminals connected to subscriber lines an optional number of which is accommodated in each of a plurality of subscriber line termination units provided in a subject device, receiving said packet; and
a packet forwarding amount regulation step of, when forwarding packets, received in said packet reception step, toward a common transmission line serving to transmit the packets toward said plurality of subscriber line termination units, regulating amounts of the respective packets forwarded to said common transmission line per unit time, depending on the packets and the terminals to which the respective packets are addressed.

13. A multicast information delivery method comprising:
a packet reception step of, when a packet arrived is addressed to any of terminals connected to subscriber lines an optional number of which is accommodated in each of a plurality of subscriber line termination units provided in a subject device, receiving said packet,
a packet selection step of selecting multicast packets each having a plurality of destinations and unicast packets each having a single destination, from among packets received in said packet reception step; and
a multicast packet forwarding amount regulation step of, when forwarding the multicast packets and the unicast packets after being selected in said packet selection step toward a common transmission line serving to transmit the multicast packets and the unicast packets toward said plurality of subscriber line termination units, regulating amounts of the multicast packets forwarded to said common transmission line per unit time, depending on groups of the terminals to which the respective multicast packets are addressed.

14. A multicast information delivery method according to claim 13, wherein said multicast packet forwarding amount regulation step sets a ratio of a total amount of the multicast packets occupying a maximum allowable amount of packets that are forwarded to said common transmission line, to a predetermined upper limit value.
